(19) United States
(12) Patent Application Publication
(10) Pub. No.: US 2007/0168734 A1
(43) Pub. Date: Jul. 19, 2007

(54) Apparatus, system, and method for persistent testing with progressive environment sterilzation

(76) Inventor: Phil Vasile, San Jose, CA (US)

Correspondence Address: Kunzler & McKenzie, 8 EAST BROADWAY, SUITE 600, SALT LAKE CITY, UT, 84111, US

(21) Appl. No.: 11/281,646

(22) Filed: Nov. 17, 2005

(51) Int. Cl. G06F 11/00

(52) U.S. Cl. 714/33

(57) ABSTRACT

An apparatus, system, and method are disclosed for automatically testing a plurality of software test cases. The testing executes a quick test of the test cases which executes each test case in a test environment that is initialized just prior to the first test case and after subsequent test case failures. The testing further executes an adjusted test of the failing test cases in which delay parameters associated with the failing test cases are increased in accordance with a system load recorded during the quick test. Finally, the testing executes a sterilized test of the remaining failing test cases in a test environment that is initialized prior to each test case execution.

### BACKGROUND OF THE INVENTION

1. Field of the Invention

This invention relates to software testing and more particularly relates to software testing using an automated software testing system.

2. Description of the Related Art

With the advent of software development came the need for software testing. Software developers write programs which control computing devices as simple as an alarm clock and as complex as the space shuttle. Despite the best efforts of software writers, bugs creep into the code.

Software bugs must be found and fixed. In an atmosphere of job specialization and finger pointing, the job of finding bugs is often assigned to software testers. Software testers create special test systems to test software in an effort to identify bugs in software. Software engineers use many terms to identify the software being tested and the software test system. For purposes of this application, the software being tested is “the software” or “the software under test” and the test system comprising computing devices, test cases, test setup software, and the like is “the test system.”

In testing the software, testers write test cases that define a specific scenario through which the software must pass. The test case may define inputs to the software and outputs that the software must produce. The test case may include operating system configuration requirements as well as interactions with other devices and systems. For example, a tester may design a test case to test a new version of the IBM (International Business Machines) IMS (Information Management System) software product. In this example, IMS is the software under test. The tester may specify that the software under test will run on an IBM mainframe running the z/OS Version 8 operating system. The test case may test whether the software under test can successfully receive a database query from a web service client, correctly retrieve a response from an IMS database, and send the response to the web service client. The test case may define the web service client as an Apache Axis web service client running on a second mainframe, running a specific version of Linux.

After writing a test case, the tester follows the steps outlined by the test case to configure the test case environment, execute the test case steps, and determine whether the software under test properly responds as predicted by the test case. If the tester detects discrepancies between the predicted outcome and the actual outcome, then the tester flags the test case as failing. A failing test case may indicate that one of three problems exists: 1) the software under test has a bug, 2) the test case is defective, or 3) the test environment is defective. Testers and developers work together to find and fix software bugs and defective test cases. Solving these problems results in better software and more robust test cases.

However, problems caused by a defective test environment often are not true bugs or test case defects. A software engineer may spend countless hours isolating a test environment defect rather than tracking down and fixing an actual software bug. Environment defects may include failure to initialize all file systems before running a test case. To save time, a software tester may run two successive test cases without initializing all file systems to a predetermined initial state. The second test may fail because the first test case modified a critical file. Reinitializing the test environment prior to running each test case may eliminate similar environmental defects. However, reinitializing the test environment may slow down the testing process.

Another defective test environment problem relates to timing issues. Test cases often define specific outputs that the software must exhibit within specific time periods. For instance, the test case may expect IMS to respond to a web service client request within 0.2 seconds. A tester may flag the test case as failing if IMS responds in 0.3 seconds. However, IMS may respond more slowly than on previous occasions simply due to an increased system load on the mainframe. This type of test environment induced test case failure may warrant a longer wait time for the response depending on the system load during test case execution.

In many cases, a software tester automates a group of test cases using a test automation system. With a single command, a tester may start a test suite of fifty test cases. The automation system may run for several hours, using valuable computing resources to execute the entire test suite. At the conclusion of the test suite execution, the automation system reports the failed test cases. Software developers and testers must carefully track down the cause of each test case failure. Software engineers may waste valuable time examining test case failures caused by test environment defects rather than resolving software code defects.

To reduce the number of test case failures due to test environment defects, the software tester may program the test automation system to reinitialize the test environment after the execution of each test case. Additionally, the tester may program extremely long wait times for each test case to alleviate system load problems. However, these adjustments may double or triple the time required to execute the entire test suite. The software tester faces a dilemma: reduce test environment caused failures or reduce the time required to execute the test suite.

In addition, current test automation systems often generate a report with a disproportionate number of test case failures. In some instances, a single environment defect or a single software bug may cause a fifty percent test case failure rate. Knowing that a test case failure rate exceeds a certain threshold level after a limited number of test cases have been executed may cause a software tester to abort the execution of a test suite and conserve valuable computing resources. A software tester may determine the cause of the high failure rate or enlist software developers to assist in finding the cause after only a few test case failures rather than waiting several hours or days for the test suite to finish executing.

From the foregoing discussion, it should be apparent that a need exists for an apparatus, system, and method for automated test case execution that reduces the time required to execute a test suite of test cases while simultaneously eliminating test case failures caused by test environment defects. Additionally, a need exists for an apparatus, system, and method for automated test case execution that notifies testers of unusually high test case failure rates early in the execution of a test suite. Beneficially, such an apparatus, system, and method would reduce or eliminate test case failures caused by test environment defects, reduce the number of hours wasted tracking down test environment defects, and conserve test computing resources.

### SUMMARY OF THE INVENTION

The present invention has been developed in response to the present state of the art, and in particular, in response to the problems and needs in the art that have not yet been fully solved by currently available software testing systems. Accordingly, the present invention has been developed to provide an apparatus, system, and method for automatically executing a plurality of test cases that overcome many or all of the above-discussed shortcomings in the art.

A method for automating the execution of a plurality of test cases is presented. In one embodiment, the method includes executing a quick test of a test suite of test cases. The test cases that fail the quick test are compiled into a set of questionable test cases. The method further includes executing an adjusted test of the questionable test cases. The test cases that fail the adjusted test are compiled into a set of suspect test cases. The method further includes executing a sterilized test of the suspect test cases. The test cases that fail the sterilized test are compiled into a set of broken test cases.

In another embodiment, executing the adjusted test case further comprises adjusting delay parameters associated with each test case. The adjustment of the delay parameters may depend on the system load at the time of the quick test and also may depend on the number of test cases that failed during execution of the quick test.

A signal bearing medium tangibly embodying a program of machine-readable instructions executable by a digital processing apparatus to perform an operation to test a computer application is also presented. The operation of the program substantially comprises the same functions as described above with respect to the described method. The operation of the program further discloses the execution of the quick test, the adjusted test, and the sterilized test in conjunction with a test environment comprising Multiple Virtual Storage (MVS) guest machines running on a Virtual Machine (VM) operating system. The embodied program typically runs on an International Business Machines (IBM) mainframe.

A system of the present invention is also presented to progressively test a plurality of test cases in a progressively sterilized environment. The system may be embodied in software running on a single computing device or on a plurality of computing devices. The system in the disclosed embodiments substantially includes the modules and structures necessary to carry out the functions presented above with respect to the described method. In particular, the system, in one embodiment, includes a computing device, a test environment, a test suite, a control module, a quick test module, an adjusted test module, a sterilized test module and a watch module configured to carry out the functions of the described method.

The test environment may comprise a plurality of userids running on the computing device. The test suite comprises a plurality of test cases. The quick test module is configured to execute the test suite using the test environment and compile a set of questionable test cases from the set of test cases failed by the quick test module. The adjusted test module is configured to execute the set of questionable test cases in the test environment and compile a set of suspect test cases from the set of test cases failed by the adjusted test module. The sterilized test module is configured to execute the set of suspect test cases and compile a set of broken test cases from the set of test cases failed by the sterilized test module. The watch module is configured to detect testing irregularities and reinitialize the test environment and the control module in response to detected irregularities. After a re-initialization, the control module is configured to continue execution of the test cases.

The system, in one embodiment, is configured to track the execution of each test case and maintain an execution status for each test case. The system is further configured, in one embodiment, to notify an operator during the execution of the test cases if the test case failure rate exceeds a predefined threshold.

In a further embodiment, the apparatus may be configured to reinitialize the apparatus if one of the modules of the apparatus behaves irregularly and to continue testing the non-executed test cases.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a test system in accordance with the present invention;

FIG. 2 is a schematic block diagram illustrating one embodiment of a test environment in accordance with the present invention;

FIG. 3 is a schematic block diagram illustrating one embodiment of a test id in accordance with the present invention;

FIG. 4 is a schematic block diagram illustrating one embodiment of a test system in accordance with the present invention;

FIG. 5 is a schematic block diagram illustrating one embodiment of the progression of test case classifications in accordance with the present invention; and

FIG. 6 is a schematic flow chart diagram illustrating one embodiment of a test case execution method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

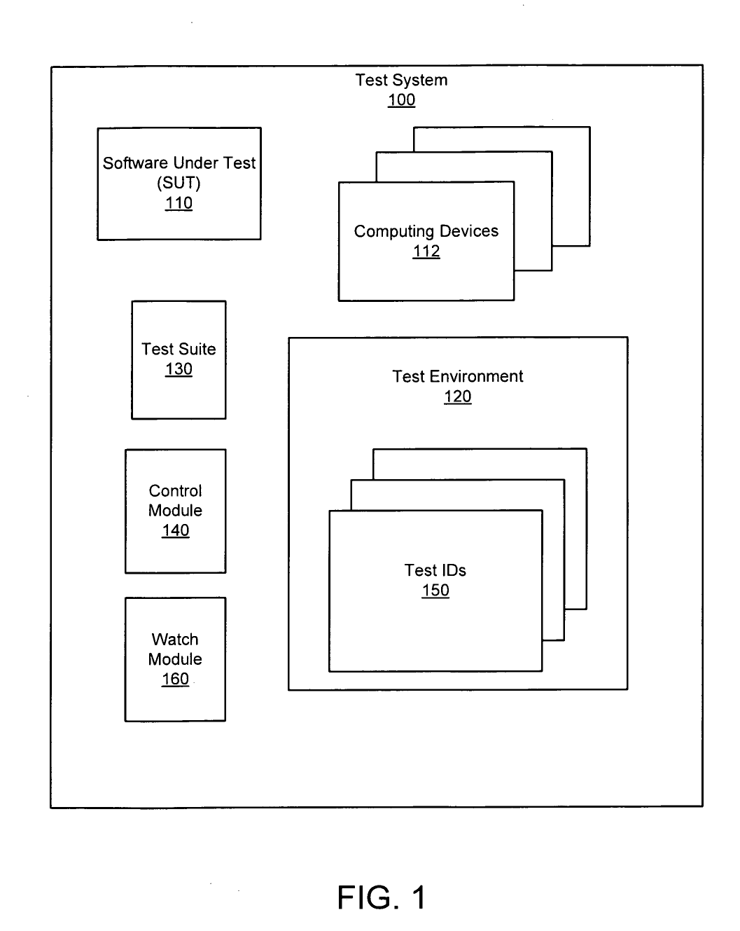

FIG. 1 illustrates a schematic block diagram of one embodiment of a test system 100 used for testing software. Software testers use the test system 100 to test newly developed software and for regression testing of released software. In a preferred embodiment, the test system 100 is configured to automatically test software with little or no human intervention. Software testing with the automated test system 100 improves software quality and customer satisfaction. Using the automated test system 100 reduces the time required to test a software product, reduces testing expenses, and shortens software development and delivery times.

The test system 100 comprises one or more computing devices 112, a test environment 120, a test suite 130, a control module 140, and a watch module 160. The test system 100 further comprises a piece of software to be tested or a software under test (SUT) 110. The computing device 112 may be a desktop computer, a specialized test computer, a mainframe, or other type of computing device. The various modules of the test system 100 may all execute on one computing device 112 or on multiple computing devices 112.

The SUT 110 is a piece of software to be tested. For example, IBM tests a new IMS version before the product is released to customers. While the new version of IMS is undergoing new release testing and regression testing, the new version of IMS is a SUT 110. The SUT 110 may be the complete new IMS version. Alternatively, the SUT 1 10 may be a module of IMS such as a transaction module or a database module. Defects found in the SUT 110 are termed software bugs or bugs. The overarching purpose of the test system 100 is to assist software engineers to find and eliminate bugs in the SUT 110.

The test environment 120 provides a controllable, reproducible simulation of a computing environment in which the SUT 110 may execute. The test environment 120 is controllable in that each element of the test environment 120 is under the control of the test system 100. The test environment 120 is reproducible in that each element of the test environment 120 is carefully defined to include specific elements and configurations. The test system 100 may recreate the test environment 120 using the same definitions and configurations to reproduce an identical test environment 120.

The test environment 120 comprises a set of test IDs 150, the computing device 112, the files, and other software products that will interact with the SUT 110. Identifying and understanding the limits of the test environment 120 assists the software tester to correctly isolate test failures and determine whether the test failure resulted from a bug in the SUT 110, a defect in the test environment 120, or a defect in a test case. In one embodiment, the test IDs 150 are userids on a single computing device 112. Alternatively, the test IDs 150 may be userids on a plurality of virtual machines running on a single computing device 112 or they may be separate physical computing devices 112.

The test suite 130 comprises the test cases to be executed by the test system 100 during a particular test run. A test case comprises a series of commands to execute in the test environment to test the SUT 110. A command may directly instruct the SUT 110 to perform an action or a command may instruct another application running in the test environment 120 to perform an action that will impact on the SUT 110. The test case may further comprise expected outputs and delay parameters. For example, a test case may issue a command to cause VTAM to display its active logic units (LUs). The expected output might comprise a list of expected active LUs. A delay parameter may indicate that VTAM should be allowed 0.5 seconds to display its active LUs. If VTAM displays the expected LUs within the delay parameters timeframe, then the SUT 110 passes the test, otherwise it fails. A test case may comprise hundreds or thousands of commands and expected outputs.

The test suite 130 is often a subset of a larger test library of test cases. The test suite 130 generally comprises test cases that require the same or similar test environments 120. If all of the test cases in a single test suite 130 use the same test environment 120, then the test system 100 need only configure the test environment 120 one time for execution of the entire test suite 130. This eliminates redundant setup processing and accelerates test case execution. Test cases in one test suite 130 may also be selected to test specific functions of the SUT 110. For instance, a series of fifty test cases in a test suite 130 may test various aspects of a database backup function.

The control module 140 controls test case execution. The control module 140 comprises logic to load a test suite 130 and execute individual test cases in the test environment 120. The control module 140 maintains an execution status for each test case by tracking whether each test case completes successfully resulting in a test case pass or completes unsuccessfully resulting in a test case failure also known as a failed test case. The control module 140 further comprises logic to initialize the test environment 120 and modify the test environment 120 when appropriate in response to test case failures. The control module 140 may notify the operator of the test system 100 of important events prior to the completion of test suite execution, including a test case failure rate that exceeds a predefined level. The control module 140 may comprise logical sub-modules that perform the functionality of the control module 140.

In one embodiment, the watch module 160 is an independent process or module that monitors various aspects of the test system 100. Under certain circumstances, the control module 140, the test environment 120, or the SUT 110 may behave irregularly. Irregular behavior or a testing irregularity comprises behavior by the SUT 110 or any module of the test system 100 including the control module 140 and the test environment 120 which delays or frustrates the execution of test cases. Irregular behavior does not include a test case failure that does not prevent the continued operation of the test system. As an example of irregular behavior, a single test ID 150 may stop responding. Alternatively, the control module 140 may hang or crash.

The control module 140 normally will monitor the test IDs 150 and reinitialize the test environment 120 in response to a test ID 150 hang. However, the control module 140 may not detect the crash of the control module 140. The watch module 160 monitors the control module 140 as well as other test system 100 modules and restarts the test system 100 upon detecting a testing irregularity such as a crash or a non-responsive module or test ID 150. The watch module 160 may also notify the operator of the test system 100 and/or log the testing irregularity event. The watch module 160 ensures that the test system 100 does not hang indefinitely. The watch module 160 may also track test case completion in coordination with the control module 140. Upon detecting an irregular condition, the watch module 160 restarts the test system 100. Following the restart, the control module 140 continues execution of the test cases according to the execution status of each test case.

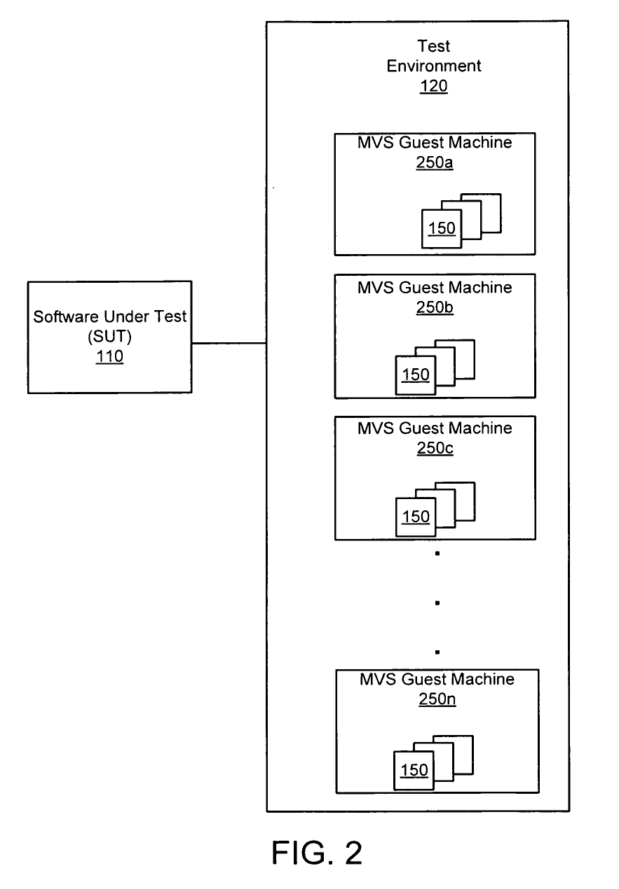

FIG. 2 illustrates a schematic block diagram of one embodiment of a test environment 120 in communication with a SUT 110. The test environment 120 comprises test IDs 150 running on MVS (Multiple Virtual Storage) guest machines 250. The term “test ID” may refer to a userid or logon for a computing device 112. In FIG. 2, a test ID 150 refers to one userid on an MVS guest machine 250 from the group of MVS guest machines 250a-n. Typically, an MVS guest machine 250 runs as a virtual machine under a VM (Virtual Machine) operating system on an IBM mainframe. Using VM, a tester may configure a test environment 120 comprising a plurality of MVS guest machines 250 running on a single IBM mainframe. In fact, a tester may configure hundreds of MVS guest machines 250 on a single IBM mainframe and execute several test suites 130 simultaneously.

FIG. 2 illustrates a single test environment 120 comprising a plurality of test IDs 150 running on MVS guest machines 250. The test environment 120 and the test IDs 150 may access and/or load the SUT 110 to test the SUT 110 according to the test cases in the test suite 130. Carefully defining the precise configuration of the test environment 120 aids testers in determining the causes of test case failures. Paramount in the design of test cases and the test environment 120 is the ability to reproduce the same inputs to the SUT 110 each time the same test case is executed. Any variation in the test environment 120 from one test case to another makes it more difficult to determine whether a test case failure resulted from a bug in the SUT 110, a defect in the test case, or a variation in the test environment 120.

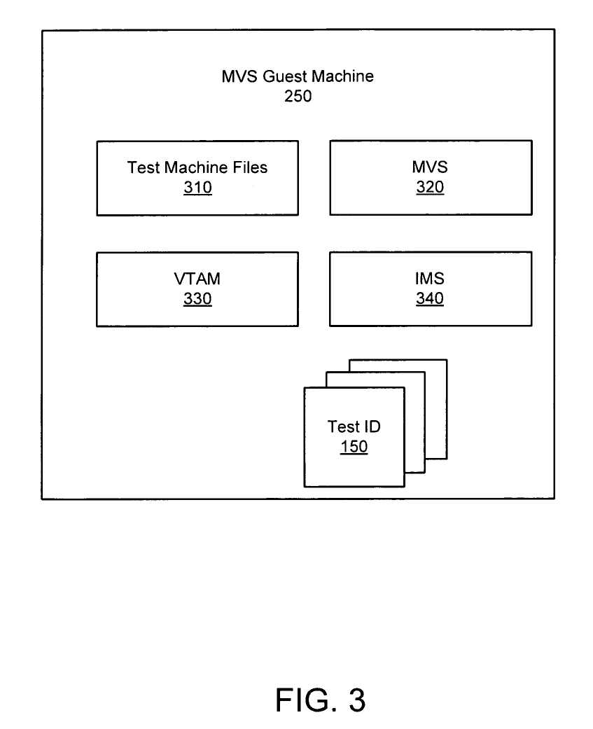

FIG. 3 is a schematic block diagram illustrating one embodiment of an MVS guest machine 250 in accordance with the present invention. One or more MVS guest machines 250 may comprise the test environment 120. Typically, the MVS guest machine 250 executes the software under test 110. Preferably, a test developer designs and configures the MVS guest machine 250 such that a reproducible MVS guest machine 250 is created each time a particular test environment 120 is initialized. One MVS guest machine 250 may vary from another MVS guest machine 250 in a test environment 120, according to the planned design of the test environment 120 and the test cases. However, each time the test system 100 executes a particular test case, a particular MVS guest machine 250 should be configured in the same way.

Typically, the MVS guest machine 250 comprises test machine files 310, an MVS operating system 320, a VTAM software product 330, an IMS software product 340, and one or more test IDs 150, as well as other application software specific to a specific test environment 120 or test case. The components of the MVS guest machine 250 in FIG. 3 are simply given for illustrative purposes. Other MVS guest machines 250 and indeed other test environments 120 without MVS guest machines 250 may be designed by those of skill in the art utilizing different modules and components to achieve the purposes of the test system 100.

The test machine files 310 provide initialization and configuration files for the software running in the MVS guest machine 250. For example, the test machine files 310 may comprise configuration files for the MVS 320 operating system and also for the VTAM 330 communications product. Occasionally, the execution of one test case modifies the test machine files 310 and thus changes the configuration of the MVS guest machine 250 and the test environment 120. Execution of a subsequent test case may be affected by such a modification to the test environment 120. Re-initialization of the test environment 120 and the MVS guest machines 250 overwrites the modified test machine files 310 and returns the test environment 120 and the MVS guest machines 250 to an initial or pristine state. In some situations, the test system 100 may execute a test case without re-initializing the test environment 120. Such a decision may accelerate test case execution; however, such a decision may cause a test case failure due to an environmental defect. The test system 100 tracks such failures and re-tests such test cases according to logic described below.

The MVS guest machine 250 uses the MVS operating system 320. In one embodiment, the MVS operating system 320 runs as a process in a virtual machine under the VM operating system. The test environment 120 may initialize the MVS operating system 320 for each MVS guest machine 250 as part of initializing of the test environment 120. The MVS operating system 320 provides to the MVS guest machine 250 the standard MVS functionality. The MVS operating system 320 relies on the test machine files 310 as well as operator commands issued by the control module 140 for proper initialization. Operator commands may be scripted as part of a test case in order to ensure uniform initialization.

The VTAM software product 330 provides communications services to the MVS guest machine 250. As with MVS 320, VTAM 330 relies on the test machine files 310 as well as scripted initialization commands to ensure uniform initialization. Similarly, the IMS software product 340 relies on the test machine files 310 as well as initialization commands to ensure uniform initialization. Other software applications or modules may also run on the MVS guest machine 250, requiring use of the test machine files 310 and also requiring initialization commands. The initialization commands may be issued by an operator through the control module 140. However, preferably, the initialization commands are scripted in an automated form to ensure uniform initialization of the test environment 120. Although MVS guest machine 250a (see FIG. 2) may differ from MVS guest machine 250b, for a given test run, MVS guest machine 250a is preferably configured identically for each execution of the same test case in order to properly isolate defects and their causes.

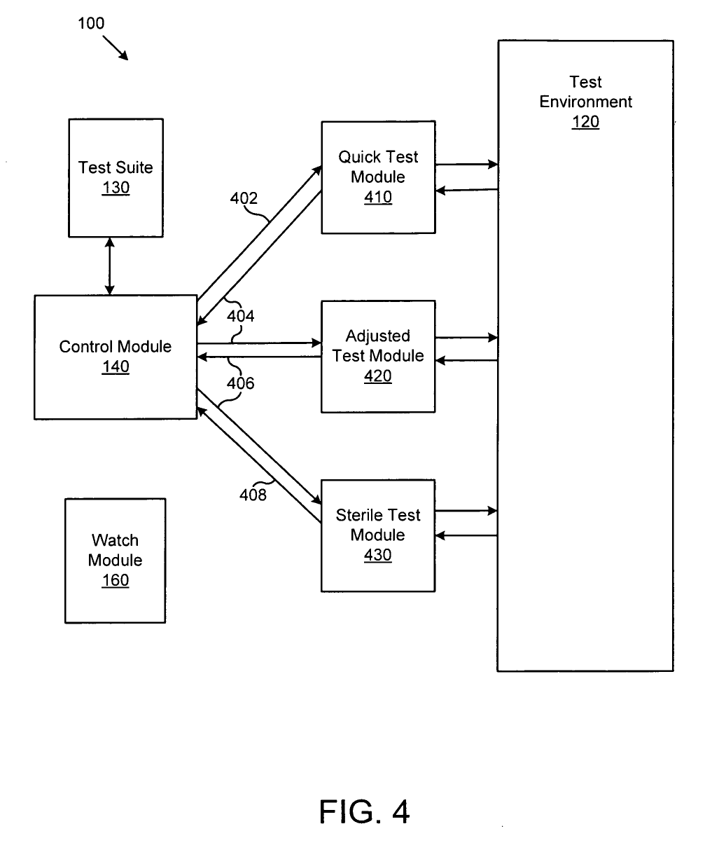

FIG. 4 is a schematic block diagram illustrating one embodiment of a test system 100 comprising a control module 140, a test environment 120, a test suite 130, and a watch module 160. The control module 140 communicates with three test modules: a quick test module 410, an adjusted test module 420, and a sterilized test module 430. The test modules 410, 420, 430 may be modules separate from the control module 140 or the test modules 410, 420, 430 may be sub-modules contained within the control module 140. Those of skill in the art will understand that the logic of the test modules 410, 420, 430 may be comprised by other modules of the test system 100 or the test modules 410, 420, 430 may exist as separate modules.

In one embodiment, the control module 140 selectively executes test cases using the logic of the test modules 410, 420,430. The control module 140 may pass control of test case execution to individual test modules 410, 420, 430 which then control the execution of the sequential steps of each test case and maintain complete control of the test environment 120. Alternatively, the control module may completely control execution of each test case and may completely control the test environment, calling the test modules 410, 420, 430 simply as subroutines or procedures to tailor the successive execution of certain test cases.

The execution of a test case may be carried out by the control module 140, by the individual test modules 410, 420, 430, or by the test environment 120. In one embodiment, the control module 140 reads script commands from a test case and sequentially executes those commands by issuing a command on a test ID 150 running on an MVS virtual machine 250 in the test environment 120. For example, the first test instruction in a test case may instruct the test system 100 to execute an operator command on a specific MVS guest machine 250 to initialize the IMS product. The control module 140 may enter the operator command on the test ID 150 on an MVS guest machine 250. The next test instruction may require the initialization of a second IMS product and so forth. Alternatively, the individual test modules 410, 420, 430 may read the test instructions and execute the test instructions on the test IDs 150. Typically, only one test case is run in one test environment 120 at a time. However, a single control module 140 may control execution of multiple test cases in a plurality of test environments 120, one test case per environment.

Each of the test modules 410, 420, 430 may comprise distinct logic to handle test environment 120 initialization and logic to modify test case execution within certain parameters. The test modules 410, 420, 430 work in coordination with the control module 140 to ensure that each test case executes under very specific test environment 120 conditions.

In one embodiment, the control module 140 is a program named LCTRUN which executes under VM. An operator logs onto a control ID representing the control module 140 and starts the LCTRUN program. The LCTRUN program creates a separate watch module 160 executing a watch program. The LCTRUN program then begins execution of a test case from a test suite 130. The test case contains a script of instructions which the LCTRUN program executes. Each instruction may comprise individual operator commands to be executed on specific test IDs 150 running on specific MVS guest machines 250. As the LCTRUN program executes, it monitors test case execution and records failures and successes for each test case.

In an alternative embodiment, an operator may execute an LCTSTART command which communicates with a plurality of control IDs. Executing the LCTSTART program causes each of the plurality of control IDs to execute an LCTRUN program. In this manner, the LCTSTART program may cause dozens of control modules 140 to execute dozens of test suites 130 simultaneously in dozens of test environments 120. In one embodiment, the LCTSTART program may control the execution of LCTRUN on separate VM machines running on separate computing devices 112 or mainframes.

Typically, the control module 140 starts execution of a set of test cases by accessing a test suite 130. The test suite 130 typically is a set of test cases which require similar or identical test environments 120. The test suite 130 may be a subset of test cases from a larger test case library. The test suite 130 comprises a set of initial test cases 402 that the control module 140 executes.

In one embodiment, the control module 140 tracks the completion of test case execution. A test case completes test case execution only after the control module 140 marks the test case as passed or broken. The control module 140 marks a test case as passed if the test case successfully completes execution under the quick test module 410, the adjusted test module 420, or the sterilized test module 430. The control module 140 marks a test case as broken only after the test case has failed execution under all three test modules 410, 420, 430.

The control module 140 successively executes test cases using the quick test module 410, the adjusted test module 420, and the sterilized test module 430 in a waterfall approach. The adjusted test module 420 tests only those test cases that fail the quick test module 410. Similarly, the sterilized test module 430 tests only those test cases that fail the adjusted test module 420. The control module 140 marks those test cases that pass the quick test module 410 as passed and does not continue executing a passed test case. The control module also marks as passed those test cases that fail the quick test module 410 and then pass the adjusted test module 420. Similarly, the control module 140 marks as passed those test cases that fail the quick test module 410 and the adjusted test module 420 and then pass the sterilized test module 430. The control module marks the test cases that fail all of the test module 410, 420, 430 as broken.

As mentioned above, the system 100 may experience a testing irregularity at any time during test execution. If the watch module restarts the system 100 due to a testing irregularity or if the system 100 stops test case execution for any reason, the system 100 may continue test case execution upon a subsequent initialization. Execution of an uncompleted test suite 130 continues after initialization of the test system 100 according to the execution status of each test case; however, the control module sets the status of the test case that was executing at the time of the testing irregularity to failed for the particular test module 410, 420, 430 under which the test case was executing.

In one embodiment, upon restarting the test system 100, the control module 140 continues execution of the test suite 130 until each test case passes one test module 410, 420, 430 or the test case fails all three test modules 410, 420, 430. Thus, test case execution for one test suite 130 continues until the control sets the execution status for each test in the test suite 130 as passed or broken.

At the start of test case execution, the control module 140 creates a set of initial test cases 402 comprising the test cases from the test suite 130. The quick test module 410 may execute the initial test cases 402 in a relatively expedited manner. The quick test module 410 initializes the test environment 120 and starts execution of the initial test cases 402, one test case at a time. The quick test module 410 tracks test case passes and test case failures, and may reinitialize the test environment 120 after each test case failure. However, the quick test module 410 preferably does not reinitialize the test environment 120 after successful test cases. Although failing to initialize the test environment 120 after each test case execution may result in a higher number of failures, the quick test module 410 favors speed of test case execution over a higher pass rate and avoids reinitializing the test environment 120 except following test case failures.

On occasion, a test case may cause the SUT 110 to hang. Alternatively, the quick test module 410 may hang, the control module 140 may hang, VTAM 330 in one MVS guest machine 250 may stop responding, or the test system 100 may otherwise exhibit a testing irregularity. The control module 140 monitors the test IDs 150 and various modules in the test system 100 for signs of test irregularities. The watch module 160 monitors the control module 140 and additionally may monitor individual test IDs 150. The control module 140 or the watch module 160 may restart the test system 100 to recover from a testing irregularity. Testing of the test suite 130 automatically continues after a restart.

As an example, in one embodiment, the control module 140 may detect that an MVS guest machine 250 no longer responds to operator commands. The control module 140 may mark the execution status of the currently executing test case as failing and restart the test environment 120.

Restarting the test environment 120 may include shutting down the test IDs 150, shutting down the MVS guest machines 250, restoring test machine files 310 on each MVS guest machine 250, initializing MVS 320 on each MVS guest machine 250, bringing up VTAM 330 on each MVS guest machine, and logging onto each test ID 150.

In another alternative scenario of the same embodiment, the watch module 160 may detect that the control module 140 no longer responds to operator display commands. The watch module 160 may then restart the control module 140 and allow the control module 140 to initialize the test environment 120 as described above. Following a restart of the control module 140, the control module continues execution of the test cases according to the recorded execution status of each test case.

From time to time, a test suite 130 may experience an unusually high failure rate. A severe software bug in the SUT 110, a test environment 120 defect, or a test case defect common to several test cases in a single test suite 130 may cause a high failure rate. Upon recognizing the occurrence of a high failure rate, a tester may abort test case execution to determine the cause of the high failure rate. Aborting test case execution as early as possible may save days of wasted testing and conserve valuable testing resources.

In one embodiment of the test system 100, the control module 140 may track test case failures during the execution of the test modules 410, 420, 430 and notify an operator if the failure rate exceeds a certain threshold. For example, the control module 140 may compare the failure rate for the first ten test cases executed by the quick test module 410 and notify an operator if the failure rate exceeds fifty percent. The control module 140 may continue monitoring failure rates throughout the testing process and notify the operator of predetermined failure rates or other events that may warrant operator intervention. Preferably, the control module 140 always reports the current pass/failure status of each test case. However, the operator may configure the control module 140 to notify the operator using an audible alert, a flashing console message, or other mechanism to highlight certain failure rates or conditions which may warrant immediate action.

At the conclusion of the quick test module 410 execution, the control module 140 marks the passing test cases as passed and compiles the failing test cases into a set of questionable test cases 404. The control module 140 continues execution of the questionable test cases 404 using the adjusted test module 420. Because the quick test module 410 does not test each test case in a pristine test environment 120 and due to the fact that system load may have contributed to some of the test case failures, the test system 100 does not yet mark the failing test cases as broken.

The adjusted test module 420 receives the questionable test cases 404 for further testing. The adjusted test module 420 reinitializes the test environment 120. Prior to executing the questionable test cases 404, the adjusted test module 420 determines whether system load during the execution of the initial test cases 402 in the quick test module 410 may have contributed to the failure of the questionable test cases 404. Some test cases are more sensitive to timing considerations and system load. Other test cases may be more sensitive to network load. The adjusted test module 420 may consider the percentage of test case failures from the quick test module 410, system load, network load, and the sensitivities of the individual test cases to various timing situations, as well as other factors. If the adjusted test module 420 determines that system load, the network load, or another timing situation may have contributed to the test case failures in the quick test module 410 or if system load is high enough to affect the upcoming testing, the adjusted test module 420 may adjust delay parameters used by the questionable test cases 404.

Delay parameters are wait times prescribed by each test case. For instance, a test case may require an IMS software product 340 to respond to a database query in one second. If the test case failed waiting for a database response from the IMS software product 340, the adjusted test module 420 may increase a delay parameter allowing the IMS software product 340 two seconds to respond to a database query.

After initializing the test environment 120 and adjusting wait parameters in accordance with system load measurements, the adjusted test module 420 executes the questionable test cases 404. All other aspects of the testing related to execution by the quick test module 410 apply to the testing carried out by the adjusted test module 420. In other words, the adjusted test module 420 reinitializes the test environment 120 only after a test case fails.

In addition, the test system 100 restarts itself if the test system 100 experiences a testing irregularity. Following a restart of the test system 100 during execution of the adjusted test module 420, the test system 100 resumes execution with the adjusted test module 420. The test system 100 may mark the test case that was executing prior to the restart as failed and continues with the questionable test cases 404 that were not yet executed by the adjusted test module 420. At the conclusion of the execution of the adjusted test module 420, the control module 140 compiles the failed test cases from the adjusted test module into a set of suspect test cases 406. However, the suspect test cases 406 are not yet marked as broken because they did not all fail in a pristine test environment 120.

The sterilized test module 430 receives the suspect test cases 406 for further testing. The sterilized test module 430 initializes the test environment 120 and executes each of the suspect test cases 406. Following each test case execution, regardless of success or failure, the sterilized test module 430 reinitializes the test environment 120. If any of the modules of the test system 100 hang or crash, the test system 100 may restart the test system 100. Following a restart, the previously executing test case is marked as failed and the sterilized test module 430 reinitializes the test environment and executes the suspect test cases 406 that have not yet been tested. The control module 140 compiles the set of failed test cases from the sterilized test module 430 as broken test cases 408.

After completion of testing, the test system 100 may generate a report detailing the passed and broken test cases. The report may comprise a final execution status for each test case including the execution status of each test case for each test module 410, 420, 430. The design of the test system 100 creates a high degree of confidence that the broken test cases 408 are broken due to software bugs or defects in the test cases rather than defects in the test environment 120. The test system 100 systematically executes each test case in an expedited fashion, in a delayed fashion as needed, and in a pristine test environment 120.

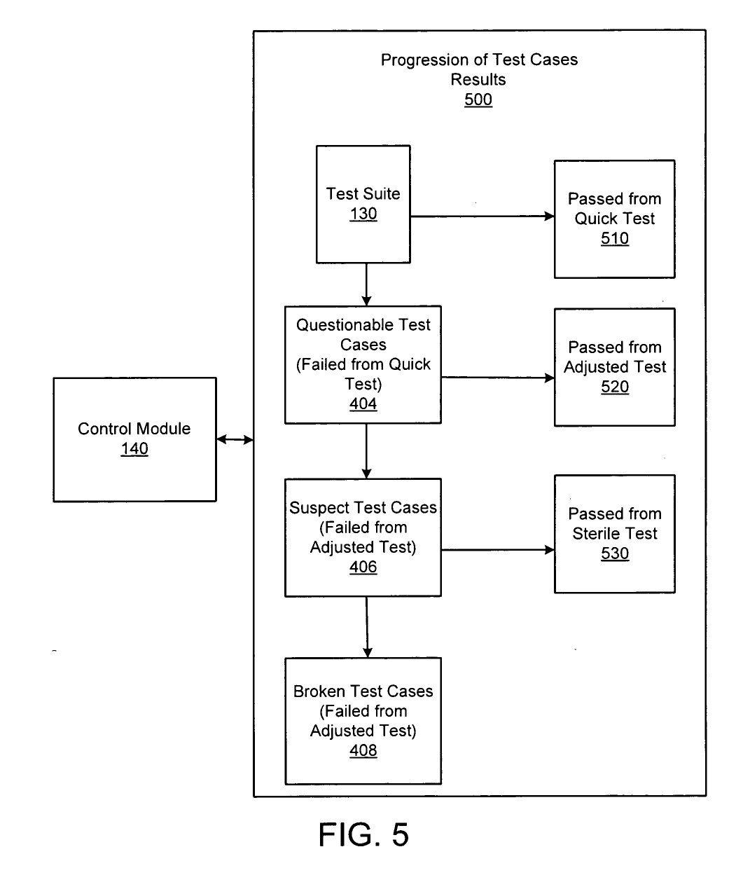

FIG. 5 is a schematic block diagram summarizing the progression of test cases 500 through the test system 100 as controlled and monitored by the control module 140 and the test modules 410, 420, 430 (see FIG. 4). The test system 100 selects a test suite 130 comprising a set of test cases that require a similar test environment 120. The quick test module 410 executes the test suite 130. The control module 140 groups test cases that pass the quick test module 410 into quick test passing test cases 510 while marking failing test cases as questionable test cases 404. The adjusted test module 420 executes the questionable test cases 404. The control module 140 groups test cases that pass the adjusted test module 420 into adjusted test passing test cases 520 while marking failing test cases as suspect test cases 406. The sterilized test module 430 executes the suspect test cases 406. The control module 140 groups test cases that pass the sterilized test module 430 into sterilized test passing test cases 530 while marking failing test cases as broken test cases 408.

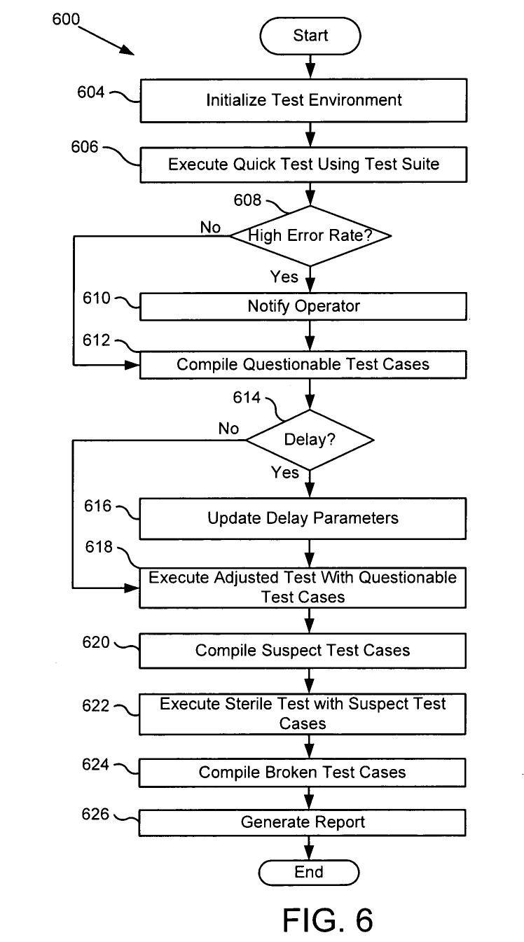

FIG. 6 is a schematic flow chart diagram illustrating one embodiment of a test case execution method 600 for executing a test suite 130 of test cases in accordance with the present invention. Initializing 604 the test environment 120 brings the test environment 120 to an initial or pristine state. The test modules 410, 420, 430 may also initialize the test environment 120 according to module specific logic described below.

During execution 606 of the quick test module 410, the test environment 120 is initialized only after test case failures. The quick test module 410 tracks test case failures and determines 608 if the test case failure rate exceeds a predetermined threshold. As an example, the operator may configure the threshold rate to be fifty percent. If the failure rate exceeds a predetermined threshold, the quick test module 410 notifies 610 the test system operator of the high failure rate. Notification alerts the operator that a severe defect in the SUT 110 or the test environment 120 may exist. Typically, a single test suite 130 may execute for several hours or several days. Timely notification of a potential severe defect may avert several days of wasted testing time and may accelerate the removal of the defect. The operator may abort the test case execution method 600 at any time.

The test system 100 compiles 612 a set of questionable test cases 404 from the test cases that failed during the execution 606 of the quick test module 410. Based on the system load during the execution of the quick test module 410 and the current system load, the test system 100 determines 614 if delay parameters should be adjusted and updates 616 the delay parameters accordingly.

The adjusted test module 420 executes 618 the questionable test cases 404. Following each test failure, the adjusted test module 420 reinitializes the test environment 120. The adjusted test module 420 compiles 620 the failing test cases into a set of suspect test cases 406.

The sterilized test module 430 executes 622 the suspect test cases 406. The sterilized test module 430 reinitializes the test environment 120 prior to each test case execution. Failed test cases are compiled 624 into a set of broken test cases 408.

Finally, the test system 100 may generate 626 a report based on the test case passes and failures. The test system 100 progressively sterilizes the test environment 120 throughout the testing process. The design of the test system 100 balances the need to verify quickly that test cases run correctly against the need to rule out test environment 120 defects before marking a test case as broken. Once the test system 100 marks a test case as broken, testers and developers can, with a high degree of certainty, look for either a defect in the test case or a bug in the SUT 110 rather than blaming the failure on a test environment 120 defect.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automating execution of a plurality of test cases, the method: comprising:
executing a quick test of a test suite comprising a plurality of test cases;
compiling a set of questionable test cases that failed the quick test;
executing an adjusted test of the questionable test cases;
compiling a set of suspect test cases that failed the adjusted test;
executing a sterilized test of the suspect test cases; and
compiling a set of broken test cases that failed the sterilized test.

2. The method of claim 1, wherein executing an adjusted test further comprises adjusting delay parameters associated with the set of questionable test cases based on the percentage of test cases that failed the quick test.

3. The method of claim 2, wherein adjusting delay parameters comprises increasing delay parameters in response to a system load of a computer system executing the quick test, adjusted test, and sterilized test.

4. A system to automate the execution of a plurality of test cases and systematically identify a set of broken test cases, the system comprising:
at least one computing device;
a test environment comprising a plurality of userids on the at least one computing device;
a test suite comprising a plurality of test cases that utilize at least one of the userids;
a quick test module configured to execute the test suite using the test environment and compile a set of questionable test cases comprising the failed test cases executed by the quick test module;
an adjusted test module configured to execute the set of questionable test cases using the test environment and compile a set of suspect test cases comprising the failed test cases executed by the adjusted test module, wherein the adjusted test module initializes the test environment prior to execution of the set of questionable test cases and subsequent to the failed execution of a questionable test case and wherein the adjusted test module increases delay parameters associated with the set of questionable test cases based on a percentage of failed test cases from the execution of the test suite by the quick test module;
a sterilized test module configured to execute the set of suspect test cases using the test environment and compile a set of broken test cases comprising the failed test cases executed by the sterilized test module, wherein the sterilized test module initializes the test environment prior to executing each suspect test case;
a control module configured to control execution of the quick test module, the adjusted test module, and the sterilized test module; and
a watch module configured to detect a testing irregularity and reinitialize the control module in response to the detected irregularity in the control module, such that the control module continues execution.

5. The system of claim 4, the control module further configured to track an execution status of each test case based on the results of the execution of the test case by the quick test module, the adjusted test, and the sterilized test module.

6. The system of claim 5, the control module further configured to notify a system operator of test case failures that exceed a threshold, wherein the notification is sent prior to the completion of the execution of the test suite.

7. The system of claim 5, the control module further configured to generate a report of broken test cases.

8. The system of claim 5, the control module further configured to continue execution of the test suite in response to the re-initialization of the control module according to the execution status of each test case.

9. The system of claim 4, wherein the at least one computing device comprises at least one International Business Machines (IBM) mainframe running the Virtual Machine (VM) operating system and the test environment comprises Multiple Virtual Storage (MVS) guest machines running under the VM operating system.

10. The system of claim 9, wherein the control module is further configured to initialize the test environment to an initial state prior to execution of test cases by the quick test module, the adjusted test module, and the sterilized test module.

11. The system of claim 10 wherein initializing the test environment comprises copying a set of initialization files to each MVS guest machine.

12. The system of claim 11, wherein initializing the test environment further comprises initializing each MVS guest machine by initializing MVS, Virtual Telecommunications Access Method (VTAM) and Information Management System (IMS) according to specifications associated with the test suite.

13. A signal bearing medium tangibly embodying a program of machine-readable instructions executable by a digital processing apparatus to perform an operation to test a computer application the operation comprising:
executing a quick test of a test suite comprising a plurality of test cases configured to execute in a test environment comprising Multiple Virtual Storage (MVS) guest machines running on a Virtual Machine (VM) operating system on a mainframe;
compiling a set of questionable test cases that failed the quick test;
increasing delay parameters in the questionable test cases in accordance with the percentage of questionable test cases compared to the plurality of test cases
executing an adjusted test of the questionable test cases;
compiling a set of suspect test cases that failed the adjusted test;
executing a sterilized test of the suspect test cases;
compiling a set of broken test cases that failed the sterilized test;
maintaining an execution status for each test; and
monitoring the execution of the quick test, the adjusted test, and the sterilized test for a testing irregularity and restarting the execution of the quick test, the adjusted test, and the sterilized test in response to a detected testing irregularity according to the execution status of each test case.

14. The signal bearing medium of claim 13, wherein the instructions further comprise lengthening the delay parameters in accordance with a system load during the execution of the quick test.

15. The signal bearing medium of claim 13, wherein the instructions further comprise lengthening the delay parameters in accordance with a system load during the execution of the adjusted test.

16. The signal bearing medium of claim 13, wherein maintaining the execution status of each test case comprises tracking for each test case successful and failed completion of the execution of the quick test, the adjusted test, and the sterilized and wherein restarting the execution of the quick test, the adjusted test, and the sterilized test comprises completing the execution of each test case having no execution status.

17. The signal bearing medium of claim 13, wherein a service person causes the instructions to be executed to validate the integrity of a software installation.

18. The signal bearing medium of claim 13, wherein executing an adjusted test further comprises initializing the test environment to an initial state prior to executing the questionable test cases.

19. The signal bearing medium of claim 18, wherein executing an adjusted test further comprises detecting a failure of a questionable test case and initializing the test environment to the initial state prior to executing a next questionable test case.

20. The signal bearing medium of claim 19, wherein executing a sterilized test further comprises initializing the test environment to the initial state prior to executing each test case from the set of suspect test cases.
